(19) United States
(12) Patent Application Publication
(10) Pub. No.: US 2026/0104914 A1
(43) Pub. Date: Apr. 16, 2026

(54) CONTROL PROTOCOL TO ENABLE INDIVIDUAL THREADS TO ISSUE COMMANDS

(71) Applicants: Advanced Micro Devices, Inc., Santa Clara, CA (US); XILINX, INC., San Jose, CA (US)

(72) Inventors: Tobias Alonso PUGLIESE, Dublin (IE); Brandon K. POTTER, Austin, TX (US); Lucian PETRICA, Dublin (IE)

(21) Appl. No.: 18/915,197

(22) Filed: Oct. 14, 2024

(51) Int. Cl. G06F 9/48

(52) U.S. Cl. CPC G06F 9/4843

(57) ABSTRACT

Embodiments herein describe a method including posting a persistent work request (P-WR) to a memory space accessible by a control frontend (CFE), the P-WR including information about data chunks, ringing a doorbell in a control frontend (CFE), allowing the CFE to inspect the P-WR, allowing the CFE to set up virtual doorbells at specific addresses in the memory space, specifying a doorbell address range and completion flags associated with one or a set of data chunks, and allowing the CFE to set up a required data movement for each data chunk and provide completion status.

### TECHNICAL FIELD

Examples of the present disclosure generally relate to processors, and, in particular, to a control protocol enabling individual threads to issue commands without synchronizing with each other.

### BACKGROUND

In graphics processing units (GPUs), compute units (CUs) may perform fine-grained access to remote memory, which is beneficial for tasks such as distributed computing, data sharing across nodes, and parallel processing in large-scale systems. This fine-grained access allows for efficient utilization of memory resources, enabling GPUs to handle complex computations across different memory spaces without the need for large, monolithic data transfers. However, there is a fixed-size overhead to initiate remote memory accesses (RMAs), which dominate when the memory operations are small.

Each individual RMA incurs a latency cost, which accumulates when multiple fine-grained accesses are performed in rapid succession. This latency overhead may impact the performance of GPU-accelerated applications, as the overhead spent creating RMA requests can outstrip the computational gains achieved through parallelism. Consequently, optimizing RMA patterns and reducing latency is valuable to fully leveraging the computational power of GPUs in distributed environments.

### SUMMARY

One embodiment described herein is a method including posting a persistent work request (P-WR) to a memory space accessible by a control frontend (CFE), the P-WR including information about data chunks, ringing a doorbell in a control frontend (CFE), allowing the CFE to inspect the P-WR, allowing the CFE to set up virtual doorbells at specific addresses in the memory space, specifying a doorbell address range such that one doorbell and one completion flag correspond to one data chunk of the data chunks, and allowing the CFE to set up a required data movement for each data chunk and provide completion status.

One embodiment described herein is a system including a control frontend (CFE) and a memory space that receives a persistent work request (P-WR) including information about data chunks, where an application rings a doorbell in the CFE such that the CFE inspects the P-WR, sets up virtual doorbells at specific addresses in the memory space, and specifies a doorbell address range such that one doorbell and one completion flag correspond to one data chunk of the data chunks, and allows the CFE to set up a required data movement for each data chunk and provide completion status.

One embodiment described herein is a system including a graphics processing unit (GPU) running multiple GPU threads and a control frontend (CFE) communicating with the GPU, wherein the CFE sets up a memory space according to information received from a persistent work request (P-WR) including information about data chunks, and wherein the GPU threads write notifications indicating that a transfer operation needs to be constructed from the P-WR and issued to a transport engine.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a graphics processing unit (GPU) in communication with a network interface card (NIC), according to an example.

FIG. 2 illustrates a thread initiating a chunked transfer for a PUT operation, according to an example.

FIG. 3 illustrates how several approximately simultaneous chunk PUT operations are coalesced into a single larger remote direct memory access (RDMA) transfer, according to an example.

FIG. 4 illustrates a structure of the NIC, according to an example.

FIG. 5 illustrates chunk coalescing.

FIG. 6 illustrates a method for using a control protocol between a GPU and a NIC that enables individual threads to issue commands to the NIC without synchronizing with each other, according to an example.

FIG. 7 is a block diagram of an accelerator unit (AU) configured to execute workloads for applications running on a processing system, in accordance with some embodiments.

FIG. 8 is a block diagram of a data processing unit (DPU) that may be used to implement a network interface controller/card (NIC), in accordance with some embodiments.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Efficiently moving data over a network while a graphics processing unit (GPU) is simultaneously computing at peak capacity is a complex task that involves optimizing both computation and communication. Communicating GPU-computed data efficiently is beneficial in high-performance computing and machine learning (ML) applications. Two common approaches for this are the proxy thread approach and GPU direct communication.

In the proxy-thread approach, a central processing unit (CPU) thread (i.e., the proxy thread) is responsible for handling the communication of data between the GPU and other components (e.g., other GPUs or storage devices). The GPU performs computations and stores the results in its memory. A dedicated CPU thread is activated to handle data transfer. The proxy thread transfers data from the GPU memory to the desired destination (another GPU, CPU memory, storage, etc.) via traditional methods (e.g., peripheral component interconnect express (PCIe)). One issue with such approach is the additional overhead due to the context switching between CPU and GPU. Another issue is that there are more GPU threads than CPU threads, and while the CPU is handling a request for one GPU thread, the other GPU threads are waiting, which results in longer latency as the other GPU threads wait. This can be mitigated to some extent by using more proxy threads. However, by design, there are always many more GPU threads than CPU threads. As such, the proxy thread approach is not scalable to fine-grained communication initiated by many GPU threads.

In the GPU direct communication approach, direct communication is permitted between GPUs and other components, bypassing the CPU to reduce latency and improve bandwidth. The GPU performs computations and stores the results in its memory. Using the GPU direct communication approach, data is transferred directly from the GPU memory to the destination (e.g., another GPU, network interface card, or storage device) without involving the CPU.

Techniques used in memory management, especially in systems like GPUs, include fine-grained interleaving and coarse-grain interleaving. Fine-grained interleaving of GPU tasks refers to a technique used to maximize the utilization and efficiency of a GPU by concurrently executing multiple tasks or streams of work. This approach contrasts with coarse-grained interleaving, where tasks are executed sequentially or with less frequent context switching. Fine-grained interleaving leverages the parallel processing capabilities of GPUs to keep all available resources as busy as possible. By leveraging fine-grained interleaving, developers can maximize the performance of GPU applications, achieving higher utilization and efficiency, especially in scenarios involving high concurrency and low latency. Coarse-grained interleaving refers to a technique where tasks or processes are executed in larger, less frequent chunks or intervals, as opposed to being split into smaller, rapidly alternating segments. Stated differently, coarse-grained interleaving refers to the scheduling and execution of tasks or kernels in larger, less frequent intervals, as opposed to breaking them into smaller chunks and frequently switching between them. This approach is used to manage and schedule tasks, particularly in environments where the overhead of frequent context switching is undesirable or where tasks have more significant resource requirements.

A GPU kernel is a function written in a programming language such as CUDA C/C++ or OpenCL C that runs on the GPU rather than the CPU. The kernel is executed by many parallel threads on the GPU, taking advantage of the GPU's architecture to perform highly parallel computations efficiently. A GPU thread is the smallest unit of execution in a GPU's parallel computing architecture. Each thread executes a copy of a kernel function, processing different pieces of data. Threads are designed to run concurrently, leveraging the massive parallel processing capabilities of the GPU.

GPU threads are designed to execute in parallel. A single GPU can run thousands of threads simultaneously, allowing it to handle large-scale computations efficiently. GPU threads are lightweight compared to CPU threads. They have minimal scheduling overhead, allowing for the creation and management of a large number of threads with low latency. The term “lightweight” implies minimal overhead associated with thread creation and management.

For high computational efficiency in distributed applications, it is desirable to enable compute units (CUs) of GPUs to perform fine-grained accesses to remote memory, which allows fine-grained interleaving of computation and communication during application execution. This interleaving is beneficial because the GPU scheduler can theoretically hide communication latencies by scheduling other unrelated work on the CUs while the remote memory access is ongoing, without forcing the application developer to explicitly implement overlap between communication and computation.

However, this fine-grained, thread-level communication approach results in communication being fragmented in many small remote memory accesses (RMAs), which are challenging because latency overheads for initiating the remote memory access are incurred for every one of the small RMAs, whereas coarser-grained approaches incur these latencies less often, but on the other hand, they need to synchronize the data-producing threads, which means that cycles are being wasted in barriers before communication. Currently no solutions exist that solve both challenges simultaneously, that is, a fine-grained, barrier-less communication with low communication-initiating overhead.

In view of such challenges, the example embodiments present innovative approaches for GPUs to move data over a network efficiently while simultaneously computing at peak capacity. The example embodiments provide a persistent GPU-direct asynchronous communication with low overhead signaling and coalescing. In GPUs, asynchronous execution involves launching kernels or memory transfers without waiting for them to complete. Low overhead signaling refers to techniques used to minimize the performance cost of communication and synchronization between threads, processes, or devices. Signaling is useful to coordinate activities, manage concurrency, and ensure that operations occur in the correct order. However, excessive signaling can introduce delays and reduce performance. Coalescing generally refers to techniques used to optimize memory access patterns to improve performance. Coalescing is especially relevant in the context of GPUs and high-performance computing, where memory access patterns can significantly impact overall efficiency. Coalescing aims to optimize how memory accesses are grouped or combined to reduce the number of memory transactions and increase bandwidth utilization. By aligning memory accesses, coalescing can reduce the latency associated with accessing memory. Properly coalesced memory accesses can increase the effective memory throughput, allowing for higher performance.

To provide a persistent GPU-direct asynchronous communication with low overhead signaling and coalescing, the example embodiment introduces a lightweight control protocol between the GPU and a network interface card (NIC). The control protocol between the GPU and NIC enables individual threads to issue commands to the NIC without synchronizing with each other, thus achieving the benefit of asynchronous thread operation and avoiding the bottleneck of the proxy thread. The control protocol leverages the reordering logic in the GPU memory hierarchy to facilitate the coalescing of several small transfers into one single larger transfer, thus making better use of network bandwidth. As such, the example embodiments present a methodology and associated control logic that allows a transfer to be set up once at a coarse-grained granularity, thus with low overhead, and subsequently executed as the individual fine-grained data segments are completed by the individual GPU threads, with the threads themselves having very low control overhead for signaling to the NIC. Therefore, the control logic approach has both the low-overhead advantage of coarse-grained communication and the asynchronicity advantages of fine-grained communication. In other words, this is a two-step approach. In a first step, data transfer is set up once at the coarse grained granularity as a large chunk of data with low overhead. Initialization of the data transfer happens only once to reduce overhead and there is no need to set up communication sessions for each small data segment. In a second step, data transfer is executed as individual fine-grained data segments are completed (without synchronization). GPU threads issue individual commands that are transferred. The data is sent in small, fine-grained segments as soon as each one is ready. This results in minimal delay or latency. Thus, the system doesn't need to incur the latency associated with each data transfer set up. The fine-grained approach allows for synchronous execution, where each data segment can be transferred as it becomes available.

One benefit of the persistent work request is removing the overhead of creating NIC requests to initiate the transfer of individual data packets. This helps minimize the overhead and the amount of time it takes for the GPU to build a work request for the NIC.

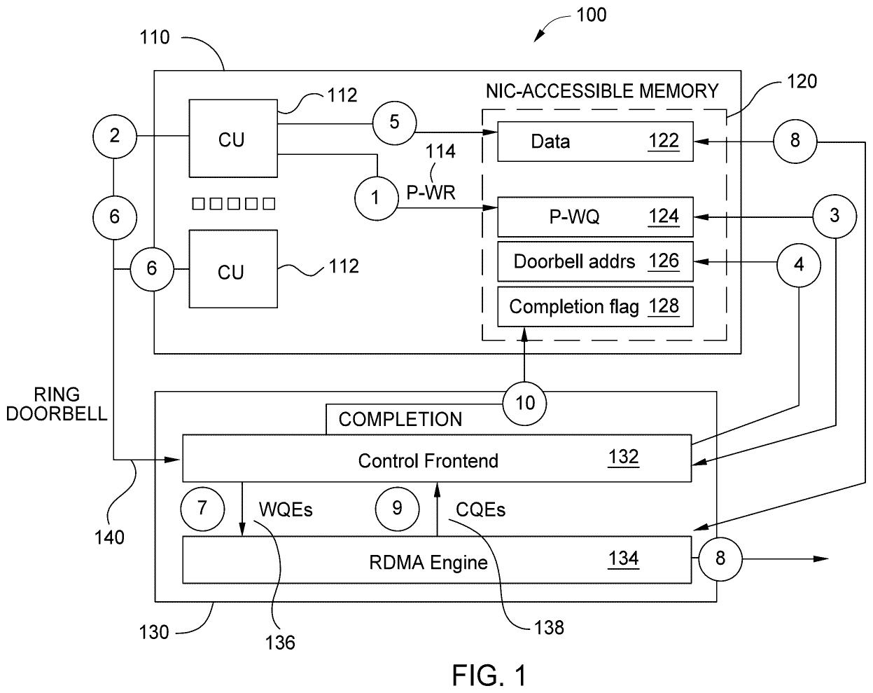

FIG. 1 illustrates a graphics processing unit (GPU) in communication with a network interface card (NIC), according to an example.

The system 100 includes a GPU 110 in communication with a NIC 130 via a control protocol. The communication between the GPU 110 and the NIC 130 occurs via an NIC-accessible memory space or memory space 120. The GPU 110 includes a plurality of compute units (CUs) 112. Each CU is responsible for executing parallel tasks. In one example, the NIC 130 may include a control front end (CFE) 132 and a remote direct memory access (RDMA) engine 134. In another example, the CFE 132 may be included or incorporated in the GPU 110. In yet another example, the CFE 132 may be implemented by a CPU thread. As such, in the description below, the CFE 132 can be either in the GPU 110 or the NIC 130. In other embodiments, the CFE 132 may be outside the GPU 110 and the NIC 130, e.g., in a CPU thread.

The CFE 132 is responsible for managing various control and management functions of the NIC 130 and implements the control protocol on the NIC side.

The RDMA engine 134 enables high-speed data transfer between the memory of, e.g., GPUs without involving the CPU, operating system (OS) kernel, or other intermediate components. This bypasses networking layers, reducing latency and CPU overhead. In other words, data is transferred directly between the source and destination memory buffers, eliminating the need for intermediate data copies. The RDMA engine 134 is one example of a data transfer protocol. In other examples, other data transfer protocols may be implemented, such as, but not limited to, transmission control protocol/internet protocol (TCP/IP) and peripheral component interconnect express (PCIe). The RDMA engine 134 may also be referred to as a transport engine.

Communication between the CFE 132 and the RDMA engine 134 within the NIC 130 involves the use of work queue elements (WQEs) 136 and completion queue elements (CQEs) 138. The work queue (WQ) is a data structure used to submit operations to the RDMA engine 134. Each operation that is to be executed by the RDMA engine 134 is encapsulated in a WQE 136. A WQE 136 includes all the information for the RDMA engine 134 to execute an RDMA operation, such as memory address, length of the data, type of operation, and any relevant control information.

The CFE 132 implements the control protocol. As such, the CFE 132 has the ability to issue the WQEs 136 to the RDMA engine 134 and to receive the CQEs 138 from it, and to mediate between the GPU-NIC protocol or control protocol (based on P-WR and doorbells/flags) and the RDMA stack. The CFE 132 creates the WQEs 136 in response to doorbell writes and sets flags in response to the CQEs 138.

In operation, the application posts a P-WR 114 to the memory space 120. The application rings a doorbell in the CFE 132. The CFE 132 retrieves the P-WR 114 and inspects it. The P-WR 114 will contain information such as, but not limited to, the number and size of data chunks for the upcoming transfer, as well as a base address of a source buffer. The P-WR 114 may be written in a persistent work queue (P-WQ) 124. The CFE 132 sets up virtual doorbells at specific addresses in the memory space 120 and the CFE 132 specifies this doorbell address range in the doorbell address location 126. In one example, there may be one doorbell per data chunk and there may be one completion flag per data chunk. In other examples, there may be multiple doorbells per data chunk. As such, in the example embodiments, there need not be a one to one mapping between a doorbell and a data chunk. Threads compute the data chunks, and when completed, put their respective data in the memory space 120. Threads ring the doorbells corresponding to the data chunk they computed. The CFE 132 generates the WQEs 136 as a response to doorbell rings. The RDMA engine 134 executes transfer of data between memory space 120 and the remote memory. The RDMA engine 134 supplies the CQEs 138 to the CFE 132. The CFE 132 writes a completion flag corresponding to the transferred chunk.

The memory space 120 includes a data buffer 122, a persistent work request (P-WR) structure 124, doorbell addresses 126, and completion flags 128. The CFE 132 sets up a virtual memory space in the NIC 130, according to information in the P-WR 114, where the GPU threads write notifications (i.e., ring doorbells) that some specific RDMA operation needs to be constructed from the P-WR 124 and issued to the RDMA engine 134.

The sequence of operations to execute a communication operation involving multiple GPU threads is shown by the operation numbers corresponding to FIG. 1.

At operation 1, the application posts the P-WR 114 into memory space 120, for example, into a persistent work queue (P-WQ) 124.

At operation 2, the application rings a doorbell in the CFE 132. The application rings the doorbell, via the doorbell mechanism 140, to notify the NIC 130 that is has posted new work (i.e., new commands) that need to be processed. The NIC 130 immediately starts inspecting the commands without delay.

At operation 3, the CFE 132 retrieves and inspects the P-WR 114. The P-WR 114 may include data chunk information related to a size and a number of data chunks, as well as a base address of a source buffer.

At operation 4, the CFE 132 sets up virtual doorbells at specific addresses in the NIC-accessible memory space 120. The virtual doorbells act as a signaling mechanism that notifies the CFE 132 for the need to process certain tasks. The doorbell address range may be specified in the doorbell address location 126.

At operation 5, each thread pushes its own data chunks to the memory. In other words, the threads compute the data chunks. When the computation is completed, the data is provided to the memory space 120.

At operation 6, threads ring their own chunk doorbells as they generate the corresponding data. Thus, each thread is associated with a separate and distinct doorbell. Per-thread doorbell addresses ensure that each thread operates independently without interference from others.

At operation 7, the CFE 132 generates the WQEs 136 as a response to each or a set of doorbell rings.

At operation 8, the RDMA engine 134 executes data transfers. The RDMA engine 134 monitors work queues for outgoing and incoming operations. The CFE 132 post work requests to these queues, specifying operations, such as a PUT operation.

At operation 9, the RDMA engine 134 delivers completions to the CFE 132. Once the RDMA engine 134 has completed the requested operations, it generates the CQEs 138. The CQEs 138 contain information regarding the status of the operation.

At operation 10, the CFE 132 populates per-chunk completion flags. For each chunk of data, the RDMA engine 134 tracks whether the transfer has been successfully completed. The completion flags 128 are used to record the status of each chunk. Stated differently, the CFE 132 writes completion flags corresponding to the transferred data chunk.

It is noted that the NIC 130 may be optional. In one example, the entire system may be integrated inside a system-on-chip (SoC) with the CUs 112, the CFE 132, and the input/output (I/O) as the frontend.

Operations 1-4 are executed only once by each thread to set up the parameters of a persistent work request in the NIC 130. These parameters, for example, may include a template RDMA WQE, which is then adapted to implement each subsequent per-thread RDMA operation. Operations 1-4 may be considered as the setup stage as the doorbells are specified, which provide for a lightweight interface for each of the threads.

Operations 3 and 4 are beneficial because the CFE 132 reserves a section of either NIC memory or GPU memory for per-thread doorbell addresses and provides these doorbell addresses 126 to the GPU threads, allowing the lightweight data movement initiation by each thread ringing its corresponding doorbell in operation 6. When a thread doorbell is rung, the NIC 130 can inspect the address of the rung doorbell and identify the thread ID and generate corresponding work to the RDMA engine 134 by modifying the template WQE in pre-specified ways, e.g., by incrementing the source/destination addresses by, e.g., chunk_size*thread_ID. In this way, each thread initiates in a lightweight manner a chunk transfer. Each doorbell address 126 is assigned to a particular chunk of the P-WR structure 124.

Operations 5-10 relate to each thread as each thread completes its data transfer. The individual threads can issue commands to the NIC 130 without synchronizing with each other. The benefits of issuing commands to the NIC 130 without having the threads synchronize with each other include increased throughput, reduced latency, better resource utilization, improved scalability, simplified design, and lower overhead.

The commands in the memory space 120 of FIG. 1 are pre-built and the GPU 110 only needs to send a notification to the NIC 130 that it needs to process a command. Stated differently, in FIG. 1, the P-WR 114 and P-WR structure 124 are generated or created outside the critical path and the doorbell addresses 126 are triggered within the command queue to trigger each of the threads. In FIG. 1, the command sequence is pre-computed outside of the critical path, then data is generated, and then a doorbell is rung for one thread. Data is generated again and another doorbell is rung. Data is generated yet again, and yet another doorbell is rung. The individual doorbell ringing continues for each thread of the threads until processing ends.

By allowing threads to issue commands independently, the NIC 130 can handle multiple operations concurrently. This parallelism can lead to higher overall throughput since threads aren't waiting for one another to complete their tasks. Independent command issuance can minimize the delay between a thread's request and its execution. This can result in lower latency, especially in high-performance applications where timely processing is critical. When threads synchronize with each other, they can create bottlenecks that limit the NIC's ability to process commands in parallel. Allowing threads to operate independently can make better use of the NIC's resources and capabilities. For systems with multiple threads, the ability to issue commands without synchronization can scale better.

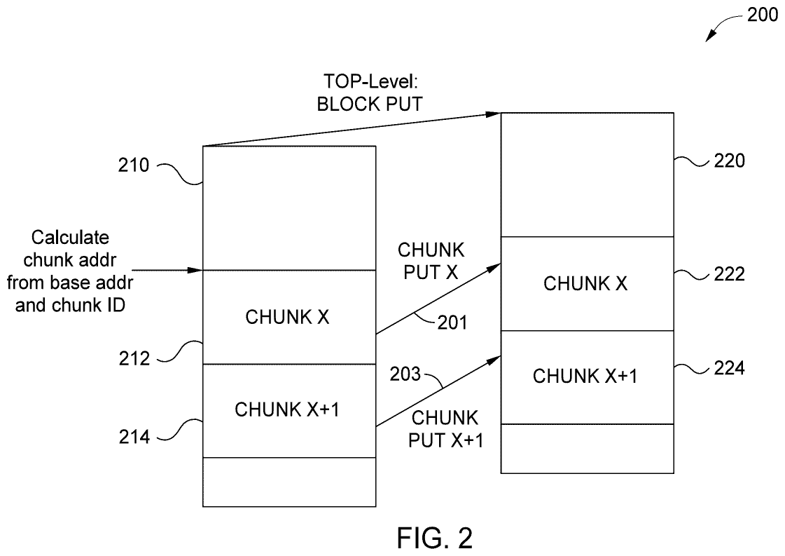

FIG. 2 illustrates a thread initiating a chunked transfer for a PUT operation, according to an example.

System 200 depicts how each thread initiates, in a lightweight manner, a chunk transfer, shown with an example PUT operation. A PUT operation is a type of data transfer or memory access operation used in distributed systems, for example when using the RDMA engine 134 of the NIC 130. In other words, a PUT operation is a type of RDMA operation where data is written from a local memory buffer (e.g., the memory space 120) to a remote memory buffer. The PUT operation is initiated by posting a work request in the memory space 120. A doorbell is rung in the CFE 132. The CFE 132 inspects the P-WR request, that is, the CFE 132 inspects the PUT operation request. The CFE 132 sets up virtual doorbells in the memory space 120 and specifies a doorbell range in the doorbell address location 126. The data chunks of the PUT operation are computed and their respective data is stored in the memory space 120. The threads ring the doorbells corresponding to the data chunk they computed.

In particular, the system 200 depicts the source buffer 210 including a first chunk address 212 (CHUNK X) and a second chunk address 214 (CHUNK X+1). The chunk addresses are determined from the base address and the chunk ID. The system 200 also depicts a destination buffer 220 including a first chunk address 222 (CHUNK X) and a second chunk address 224 (CHUNK X+1). In a first PUT operation 201, the first chunk data is written from the first chunk address 212 in the source buffer 210 to the remote address in the destination buffer 220. In a second PUT operation 203, the second chunk data is written from the second chunk address 214 in the source buffer 210 to the remote address in the destination buffer 220. As such, there is one doorbell per data chunk. Once the threads compute the data chunks, the respective data is stored in the memory space 120.

Therefore, initiating a chunk transfer using a PUT operation in a lightweight manner refers to efficiently managing multiple small data transfers where each thread handles its own chunk of data. The term “lightweight” implies minimal overhead associated with thread creation and management. Threads are designed to be efficient, with each thread handling a specific portion of the data transfer. As such, each thread is responsible for initiating and managing its own PUT operation to transfer a chunk of data.

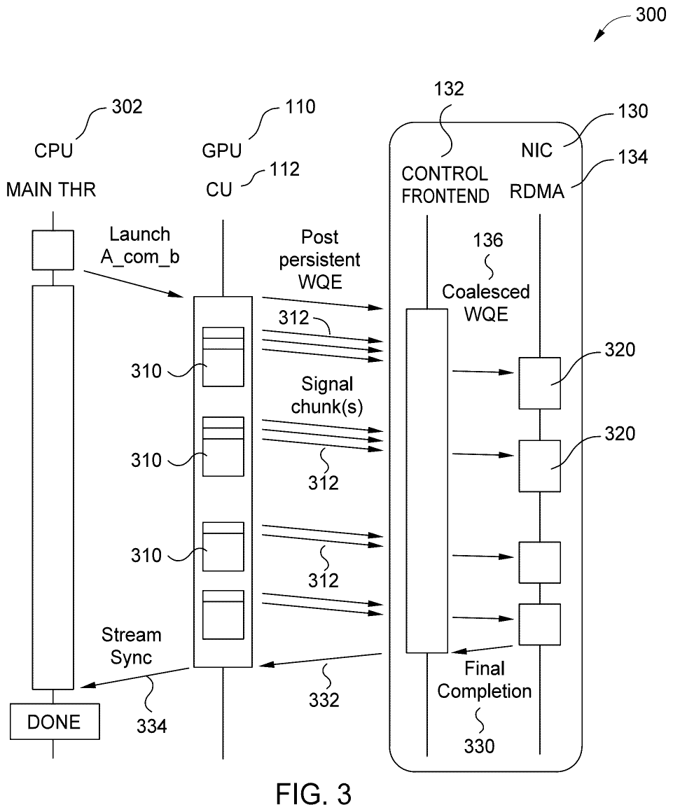

FIG. 3 illustrates how several approximately simultaneous chunk PUT operations are coalesced into a single larger remote direct memory access (RDMA) transfer, according to an example.

The system 300 depicts a CPU 302 in communication with the GPU 110, which in turn communicates with the NIC 130. The GPU includes multiple groups of threads 310. The groups of threads 310 may be referred to as wavefronts. In one example, the size of a wavefront may be, e.g., 64 threads. In other examples, the size of the wavefront may be less than or more than 64 threads. Signals 312 are sent from the CU 112 of the GPU 110 to the CFE 132. The signals 312 may be P-WRs.

In operation, the application rings a doorbell in the CFE 132. The CFE 132 retrieves the P-WR 114 and inspects it. The CFE 132 sets up virtual doorbells at specific addresses in the NIC-accessible memory space 120 and the CFE 132 specifies this doorbell address range in the doorbell address location 126. There will be one doorbell per data chunk and one completion flag per data chunk. Threads compute the data chunks, and when completed, put their respective data in the NIC-accessible memory space 120. Threads ring the doorbells corresponding to the data chunk they computed. The CFE 132 generates the WQEs 136 as a response to doorbell rings. The RDMA engine 134 executes transfer of data between NIC-accessible memory space 120 and the remote memory. The RDMA engine 134 supplies the CQEs 138 to the CFE 132. The CFE 132 writes a completion flag corresponding to the transferred chunk.

The completion queue (CQ) 330 sends the data from the NIC 130 to the GPU 110 via a signal 332. The GPU 110 can further share the data with the CPU 302 via a signal 334. The system 300 illustrates how several approximately simultaneous chunks can be coalesced into a single larger RDMA transfer. The CFE 132 can perform this coalescing if consecutive doorbells are rung in close sequence.

The advantages of initiating a chunk transfer using a PUT operation include, allowing the system 300 to handle multiple data transfers concurrently, leading to better utilization of network resources and reduced overall transfer time. Lightweight threads minimize overhead and improve efficiency, making it feasible to manage large numbers of concurrent data transfers.

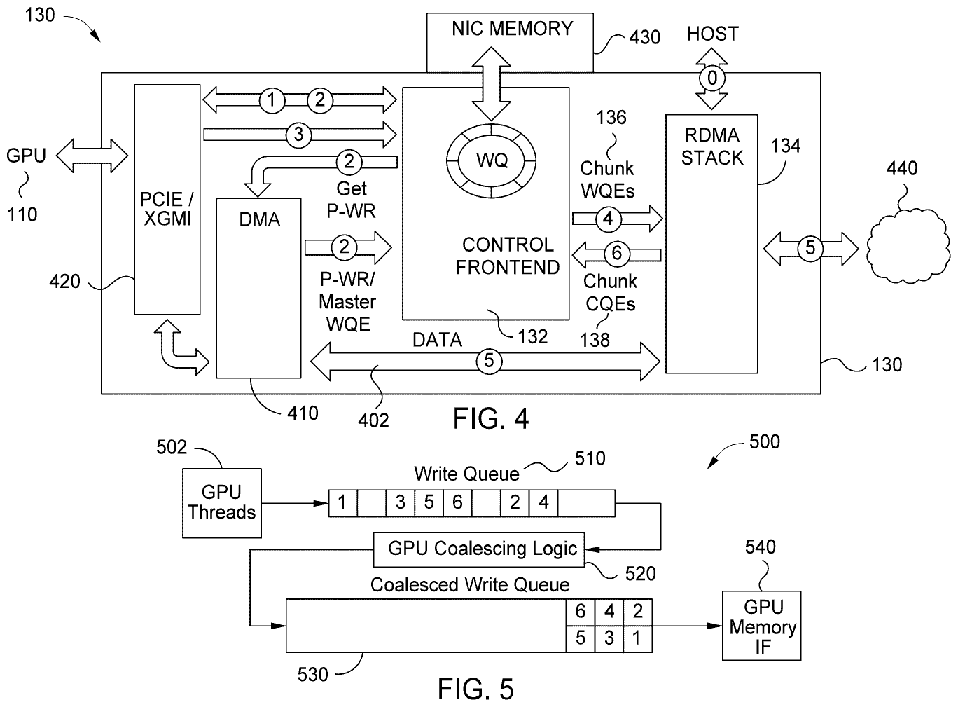

FIG. 4 illustrates a structure of the NIC, according to an example.

The GPU 110 communicates with the NIC 130. The NIC 130 includes an NIC memory 430 communicating with the CFE 132. The CFE 132 communicates with the RDMA engine 134. The CFE 132 generates WQEs 136 as a response to the doorbell rings. The RDMA engine 134 executes transfer of the data between the memory space 120 and the remote memory. The RDMA engine 134 supplies CQEs 138 to the CFE 132. The NIC 130 may communicate with one or more networks 440.

The RDMA engine 134 may also communicate with a direct memory access (DMA) 410. The RDMA engine 134 communicates with the DMA 410 to perform operations that involve accessing or manipulating memory on a remote system. This communication involves a set of operations that enable efficient, low latency data transfer 402 between the memory of different systems without the intervention of a CPU. One type of operation described herein is the PUT operation (write). However, other types of operations can also be performed. For example, a GET operation (read) can also be performed, where data is retrieved from a specified location in the remote memory and is placed in a local memory buffer. The DMA 410 may communicate with the GPU 110 via a PCIe 420.

Therefore, the NIC 130 is equipped with the CFE 132, which may be implemented as hardened logic, custom configuration of a reconfigurable fabric, e.g., a field programmable gate array (FPGA), or as a microprocessor running firmware. In some examples, the CFE 132 may also reside in GPU fabric, where it may be implemented as a special function unit in the input/output (I/O) interface as a microprocessor, hardened logic or as a custom configuration of an FPGA fabric embedded within the GPU 110.

When the master thread or initial thread rings a doorbell on the CFE 132, the CFE 132 pulls the P-WR 114 (which may include a master WQE and/or other metadata) from the P-WQ in the GPU memory, and stores relevant P-WR information in NIC memory for later use. Then the CFE 132 writes to GPU memory a specification of the per-thread doorbells, i.e., a base address of the per-thread doorbells in NIC address space, from which the addresses of individual doorbells can be identified with the formula Addr(DBi)=Base_DB_Addr+i*DB_Size. Each individual thread which produces to-be-communicated data chunks has an associated ID which can be substituted for i in the above equation to obtain the thread's individual doorbell address to ring when data is completed. Ringing each of these doorbells creates a work descriptor in the CFE 132, which is added to a work queue (WQ), which the CFE 132 manages, either in static random access memory (SRAM) or in NIC dynamic random access memory (DRAM).

The CFE 132 inspects the WQ for work items referring to consecutive chunks, which can be coalesced into a single RDMA operation. If it identifies such consecutive work items, it replaces the items with a single item. The CFE 132 subsequently pulls work descriptors from the WQ and creates WQEs 136 from them and sends these into the RDMA engine 134.

Chunk coalescing starts on the GPU 110 with the coalescing of chunk doorbell writes into contiguous consecutive writes, as illustrated with respect to FIG. 5 below. With this coalescing, the probability is increased that the NIC 130 will observe multiple consecutive chunk doorbells being rung in a single memory access from the GPU 110, indicating that the chunks can be merged into a single RDMA operation.

FIG. 5 illustrates chunk coalescing.

In system 500, the GPU threads 502 are sent to a write queue 510. The GPU threads 502 are written in different areas of the write queue. GPU coalescing logic 520 is then used to coalesce the write queue into coalesced structure 530. The GPU threads 502 are assembled together in the coalesced structure 530, and provided to the GPU memory 540. When threads access global memory, coalescing ensures that multiple memory accesses are combined into a single transaction. This reduces the number of memory transactions, decreasing latency and increasing bandwidth utilization. In shared memory, coalescing can help ensure that memory accesses by different threads are aligned, reducing bank conflicts and improving access speed. Coalescing, as presented in FIG. 5, is a technique used to optimize memory access patterns to improve performance. The example embodiments provide a persistent GPU-direct asynchronous communication with low overhead signaling and coalescing. The coalescing can be performed by the system 500.

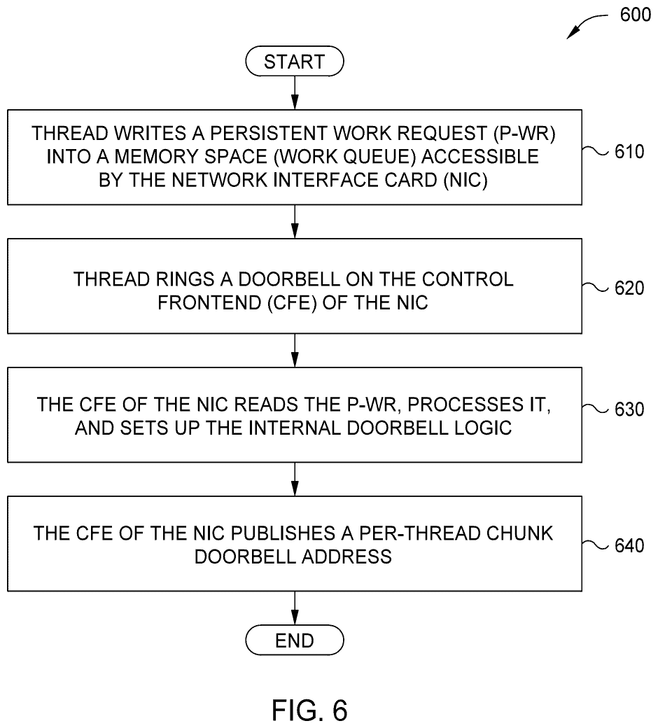

FIG. 6 illustrates a method for using a control protocol between a GPU and a NIC that enables individual threads to issue commands to the NIC without synchronizing with each other, according to an example.

At block 610, an application posts a P-WR in a memory space accessible by the NIC. The P-RW is a type of work request that remains in the P-WQ and can be reused for multiple operations.

At block 620, the application rings a doorbell on the CFE. The doorbell mechanism signals that new work is available for processing. This is performed by a specific doorbell register or doorbell address.

At block 630, the CFE reads the P-WR, processes it, and sets up the internal doorbell logic. The CFE retrieves the details of the P-WR to understand what transfer operations needs to be performed. The CFE processes the PW-R based on the specified transfer operation (e.g., a PUT operation). For a PUT operation, the CFE initiates data transfer from the local memory to a remote memory location.

At block 640, the CFE publishes a per-thread chunk doorbell address. Thus, each thread may be associated with a doorbell address. In other examples, a thread may be associated with multiple doorbell addresses. In yet other examples, multiple threads may be associated with multiple doorbell addresses. A chunk doorbell address is an address associated with a specific block of data.

The benefits of allowing threads to issue commands independently include enabling the NIC to handle multiple operations concurrently. This parallelism can lead to higher overall throughput since threads aren't waiting for one another to complete their tasks. Independent command issuance can minimize the delay between a thread's request and its execution. This can result in lower latency, especially in high-performance applications where timely processing is critical. When threads synchronize with each other, they can create bottlenecks that limit the NIC's ability to process commands in parallel. Allowing threads to operate independently can make better use of the NIC's resources and capabilities. For systems with multiple threads, the ability to issue commands without synchronization can scale better. As the number of threads increases, they can continue to operate efficiently without being constrained by synchronization overhead. When threads are allowed to operate independently, contention for shared resources is reduced. This can lead to smoother operation and fewer delays caused by thread contention. Avoiding synchronization can simplify the design and implementation of the software stack. It reduces the complexity associated with managing synchronization and can lead to more straightforward and maintainable code. Synchronization mechanisms often introduce additional overhead in terms of CPU cycles and memory usage. By eliminating or reducing synchronization, the system can save these resources and potentially improve overall performance.

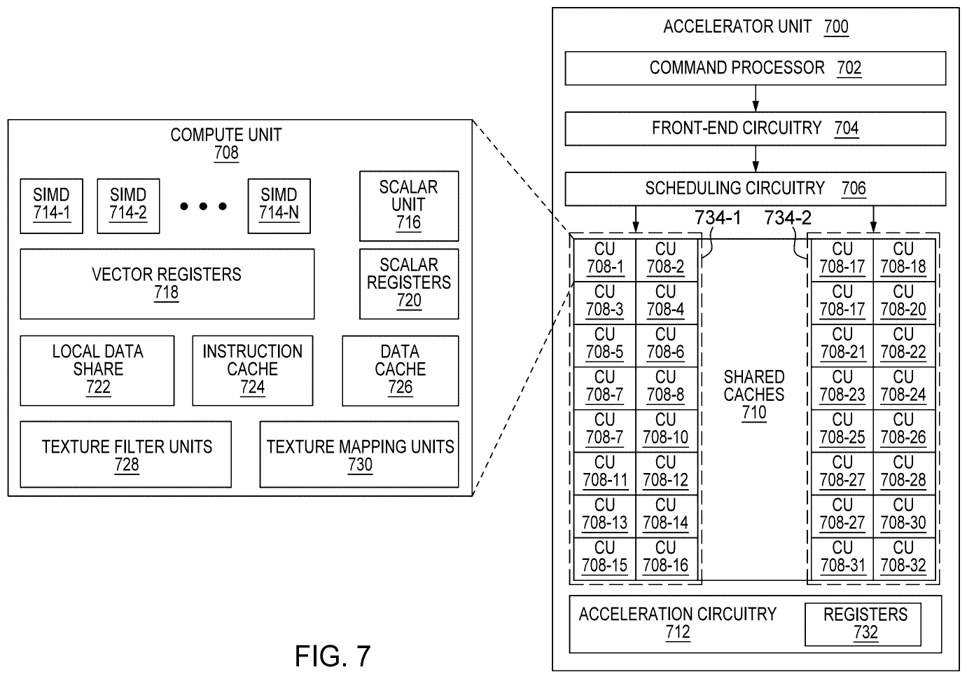

FIG. 7 is a block diagram of an accelerator unit (AU) configured to execute workloads for applications running on a processing system, in accordance with some embodiments.

FIG. 7 presents an AU 700 configured to execute workloads for one or more applications running on a processing system. These applications include, for example, compute applications, graphics applications, or both each configured to issue respective series of instructions, also referred to herein as “threads,” to a central processing unit (CPU) of the processing system. Compute applications, when executed by a processing system, cause the processing system to perform one or more computations, such as machine-learning, neural network, high-performance computing, or databasing computations. Further, graphics applications, when executed by a processing system, cause the processing system to render a scene including one or more graphics objects and, as an example, output the scene on a display. The instructions issued to the CPU from these applications, for example, include groups of threads, also referred to herein as “workgroups,” to be executed by AU 700. To perform these workgroups, AU 700 includes one or more vector processors, coprocessors, graphics processing units (GPUs), general-purpose GPUs, non-scalar processors, highly parallel processors, artificial intelligence (AI) processors, inference engines, machine-learning processors, or any combination thereof. As an example, AU 700 includes one or more command processors 702, front-end circuitry 704, scheduling circuitry 706, compute units 708, shared caches 710, and acceleration circuitry 712.

A command processor 702 of AU 700 is configured to receive, from the CPU, a command stream indicating one or more workgroups to be executed. As an example, based on a compute application running on the processing system, the command processor 702 receives a command stream indicating workgroups that require compute operations such as matrix multiplication, addition, subtraction, and the like to be performed. As another example, based on a graphics application running on the processing system, the command processor 702 receives a command stream indicating workgroups that include draw calls for a scene to be rendered. After receiving a command stream, the command processor 702 parses the command stream and issues respective instructions of the indicated workgroups to front-end circuitry 704, scheduling circuitry 706, or both. As an example, based on a command stream from a graphics application, the command processor 702 issues one or more draw calls to front-end circuitry 704 that includes one or more vertex shaders, polygon list builders, and the like. From the instructions issued from the command processor 702, front-end circuitry 704 is configured to position geometry objects in a scene, assemble primitives in a scene, cull primitives, perform visibility passes for primitives in a scene, generate visible primitive lists for a scene, or any combination thereof. For example, based on a set of draw calls received from a command processor 702, font-end circuitry 704 determines a list of primitives to be rendered for a scene. After determining a list of primitives to be rendered for a scene, the front-end circuitry 704 issues one or more draw calls (e.g., a workgroup) associated with the primitives in the list of primitives to scheduling circuitry 706.

Based on the instructions of the workgroups received from a command processor 702, front-end circuitry 704, or both, scheduler circuitry 706 is configured to provide data indicating threads (e.g., operations for these threads) to be executed for these workgroups to one or more compute units 708. Each compute unit 708 is configured to support the concurrent execution of two or more threads of a workgroup. For example, each compute unit 708 is configured to concurrently execute a predetermined number of threads referred to herein as a “wavefront.” Based on the size of the wavefront of a compute unit 708, scheduler circuitry 706 schedules one or more groups of threads of the workgroup, also referred to herein as “waves,” to be executed by the compute unit 708. As an example, scheduler circuitry 706 first updates one or more registers of a compute unit 708 such that the compute unit 708 is configured to execute a first group of waves of the workgroup. After the compute unit 708 has executed the first group of waves, scheduler circuitry 706 updates one or more registers of the compute unit 708 to schedule a second group of waves of the workgroup to be executed by the compute unit 708. To execute these waves, each compute unit is connected to one or more shared caches 710 that each include a volatile memory, non-volatile memory, or both accessible by one or more compute units 708. These shared caches 710, for example, are configured to store data (e.g., register files, values, operands, instructions, variables) used in the execution of one or more waves, data resulting from the performance of one or more waves, or both. Because a shared cache 710 is accessible by two or more compute units 708, a first compute unit 708 is enabled to provide results from the execution of a first wave to a second compute unit 708 executing a second wave. Though the example embodiment presented in FIG. 7 shows AU 700 as including 32 compute units (708-1 to 708-32), in other implementations, AU 700 can include any number of compute units 708.

Each compute unit 708 includes one or more single instruction, multiple data (SIMD) units 714, a scalar unit 716, vector registers 718, scalar registers 720, local data share 722, instruction cache 724, data cache 726, texture filter units 728, texture mapping units 730, or any combination thereof. A SIMD unit 714 (e.g., a vector processor) is configured to concurrently perform multiple instances of the same operation for a wave. For example, a SIMD unit 714 includes two or more lanes each including an arithmetic logic unit (ALU) and each configured to perform the same operation for the threads of a wave. Though the example embodiment presented in FIG. 7 shows a compute unit 708 including three SIMD units (714-1, 714-2, 714-N) representing an N number of SIMD units, in other implementations, a compute unit 708 can include any number of SIMD units 714. Further, as an example, the size of a wavefront supported by AU 700 is based on the number of SIMD units 714 included in each compute unit 708. To determine the operations performed by the SIMD units 714, each compute unit 708 includes vector registers 718 formed from one or more physical registers of AU 700. These vector registers 718 are configured to store data (e.g., operands, values) used by the respective lanes of the SIMD units 714 to perform a corresponding operation for the wave. Additionally, each compute unit 708 includes a scalar unit 716 configured to perform scalar operations for the wave. As an example, the scalar unit 716 includes an ALU configured to perform scalar operations. To support the scalar unit 716, each compute unit 708 includes scalar registers 720 formed from one or more physical registers of accelerator unit 700. These scalar registers 720 store data (e.g., operands, values) used by the scalar unit 716 to perform a corresponding scalar operation for the wave.

Further, each compute unit 708 includes a local data share 722 formed from a volatile memory (e.g., random-access memory) accessible by each SIMD unit 714 and the scalar unit 716 of the compute unit 708. That is to say, the local data share 722 is shared across each wave concurrently executing on the compute unit 708. The local data share 722 is configured to store data resulting from the execution of one or more operations for one or more waves, data (e.g., register files, values, operands, instructions, variables) used in the execution of one or operations for one or more waves, or both. As an example, the local data share 722 is used as a scratch memory to store results necessary for, aiding in, or helpful for the performance of one or more operations by one or more SIMD units 714. The instruction cache 724 of a compute unit 708, for example, includes a volatile memory, non-volatile memory, or both configured to store the instructions to be executed for one or more waves to be executed by the compute unit 708. Further, the data cache 726 of a compute unit 708 includes a volatile memory, non-volatile memory, or both configured to store data (e.g., register files, values, operands, variables) used in the execution of one or more waves by the compute unit 708. The instruction cache 724, data cache 726, shared caches 710, and a system memory, for example, are arranged in a hierarchy based on the respective sizes of the caches. As an example, based on such a cache hierarchy, a compute unit 708 first requests data from a controller of a corresponding data cache 726. Based on the data not being in the data cache 726, the data cache 726 requests the data from a shared cache 710 at the next level of the cache hierarchy. The caches then continue in this way until the data is found in a cache or requested from the system memory, at which point, the data is returned to the compute unit 708. Additionally, each compute unit 708 includes one or more texture mapping units 730 each including circuitry configured to map textures to one or more graphics objects (e.g., groups of primitives) generated by the compute units 708. Further, each compute unit 708 includes one or more texture filter units 728 each having circuitry configured to filter the textures applied to the generated graphics objects. For example, the texture filter units 728 are configured to perform one or more magnification operations, anti-aliasing operations, or both to filter a texture.

Additionally, to help perform instructions for one or more workgroups, AU 700 includes acceleration circuitry 712. Such acceleration circuitry 712 includes hardware (e.g., fixed-function hardware) configured to execute one or more instructions for one or more workgroups. As an example, acceleration circuitry 712 includes one or more instances of fixed function hardware configured to encode frames, encode audio, decode frames, decode audio, display frames, output audio, perform matrix multiplication, or any combination thereof. To schedule instructions for execution on such hardware, scheduling circuitry 706 is configured to update one or more physical registers 732 of AU 700 associated with the hardware. In some cases, AU 700 includes one or more compute units 708 grouped into one or more shader engines 734.

Referring to the embodiment presented in FIG. 7, for example, AU 700 includes compute units 708-1 to 708-16 grouped in a first shader engine 734-1 and compute units 708-17 to 708-32 grouped in a second shader engine 734-2. Such shader engines 734, for example, are configured to execute one or more workgroups (e.g., one or more compute kernels) for an application and include one or more compute units 708, graphics processing hardware (e.g., primitive assemblers, rasterizers), one or more shared caches 710, render backends, or any combination thereof. Though the embodiment presented in FIG. 7 shows AU 700 as including two shader engines (734-1, 734-2), in other implementations, AU 700 can include any number of shader engines (734-1, 734-2).

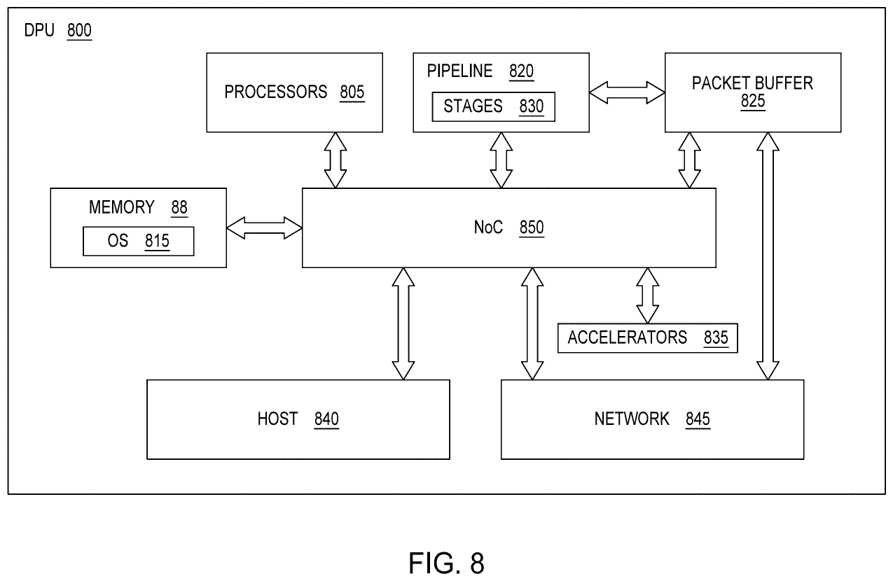

FIG. 8 is a block diagram of a data processing unit (DPU) that may be used to implement a network interface controller/card (NIC), in accordance with some embodiments.

In one embodiment, the DPU 800 is a programmable processor designed to efficiently handle data-centric workloads such as data transfer, reduction, security, compression, analytics, and encryption, at scale in data centers. The DPU 800 can improve the efficiency and performance of data centers by offloading workloads from a host central processing unit (CPU) or graphic processing units (GPUs). While CPUs and GPUs can specialize on compute, the DPU may specialize in data movement. The DPU 800 can communicate with host CPUs and GPUs to enhance computing power and the handling of complex data workloads.

The DPU 800 includes a plurality of processors 805. In one embodiment, the processors 805 include any number of processing cores. In one embodiment, the processors 805 may be CPUs. The processors 805 can form one or more CPU core complexes. The processors 805 can be any hardware circuitry that uses an instruction set architecture (ISA) to process data, such as a complex instruction set computer (CISC) or reduced instruction set computer (RISC).

The memory 810 can include volatile or non-volatile memory such as random access memory (RAM), high bandwidth memory (HBM), and the like. The memory 810 can include an operating system (OS) 815 that is separate from the host OS.

In one embodiment, the DPU may be in (or be used to implement) a network interface controller/card (NIC) such as a SmartNIC that processes packets before they are forwarded to a host (e.g., a host CPU or GPU). In one embodiment, the DPUs 800 are fully programmable P4 DPUs. The DPU 800 includes multiple pipelines 820 (which can be the same type or different types) for processing received network packets stored in a packet buffer 825. In this example, the pipelines 820 has direct connections to the packet buffer 825.

The pipelines 820 can operate in parallel. Further, the pipelines 820 can be the same type of pipeline (e.g., perform the same tasks). In other embodiments, the DPU 800 may have different types of pipelines 820. For example, the DPU 800 could include networking pipelines which perform networking tasks such as combining packets that were subdivided to be compatible with a maximum transmission unit (MTU) or for dealing with one or more host operating systems, drivers, and/or message descriptor formats in host memory, and could also include direct memory access (DMA) pipelines which perform memory reads and writes.

The pipelines 820 include multiple stages 830 where received packet data is processed at each stage 830 before being passed to the next stage. This packet data could be the entire packet or just a portion of the packet. For example, a parser in the DPU 800, which is upstream from the pipelines 820, may parse out a particular portion of a received packet (e.g., a packet header vector (PHV)) which is then sent to the one of the pipelines 820.

The stages 830 can include circuitry or hardware. In one embodiment, the stages 830 can be programmed using a pipeline programming language, such as P4. In one example, the stages 830 in one pipeline 820 perform the same functions of the stages 830 in another pipeline 820. However, in other embodiments, the stages may perform different functions.

In addition to the stages, the pipelines 820 may each include memory, which can be referred to as local memory. This memory can store local tables that indicate how, or if, a particular packet should be processed at the stages 830. For example, one of the stages in the pipelines 820 can perform a lookup to read a policing entry in a table to determine whether an entity associated with the packet has exceeded a rate limit (e.g., a packet rate limit, a data rate limit, or both).

The DPU 800 can include accelerators 835 to perform specialized tasks associated with data movement. The accelerators 835 can include a cryptography accelerator, a data compression accelerator, as well as accelerators for performing regex or dedupe.

To communicate with the host and a network, the DPU 800 includes host input/output (IO) 840 and network IO 845. The host IO 840 can include a PCIe interface, or any suitable protocol for communicating with a CPU or GPU in the host.

The network IO 845 can include Ethernet interfaces, and the like for communicating with a network.

The DPU 800 includes a network on chip (NoC) 850 for interconnecting the various components discussed above. While a NoC is disclosed, the DPU 800 can include any suitable on-chip network. While some components in the DPU 800 may rely on the NoC 850 to communicate with other components, the DPU 800 can also include connections between components that bypass the NoC 850. For example, the packet buffer 825 can have a connection to the network IO 845 that bypasses the NoC 850. Similarly, the pipelines 820 can exchange packet data with the packet buffer 825 without having to rely on the NoC 850. However, to transfer data to the processors 805, the pipelines 820 may use the NoC 850.

In one embodiment, the DPU 800 includes security and management features such as offering a hardware root of trust, secure boot, and the like.

In conclusion, the example embodiments provide a persistent GPU-direct asynchronous communication with low overhead signaling and coalescing, the example embodiment introduce a lightweight control protocol between the GPU and a NIC. The control protocol between the GPU and NIC enables individual threads to issue commands to the NIC without synchronizing with each other, thus achieving the benefit of asynchronous thread operation and avoiding the bottleneck of the proxy thread. The control protocol leverages the reordering logic in the GPU memory hierarchy to facilitate the coalescing of several small transfers into one single larger transfer, thus making better use of network bandwidth. As such, the example embodiments present a methodology and associated control logic that allows a transfer to be set-up once at a coarse-grained granularity, thus with low overhead, and subsequently executed as the individual fine-grained data segments are completed by the individual GPU threads, with the threads themselves having very low control overhead for signaling to the NIC. Therefore, the control logic approach has both the low-overhead advantage of coarse-grained communication and the asynchronicity advantages of fine-grained communication.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A method comprising:
posting a persistent work request (P-WR) to a memory space accessible by a control frontend (CFE), the P-WR including information about data chunks;
ringing a doorbell in the CFE;
allowing the CFE to inspect the P-WR;
allowing the CFE to set up virtual doorbells at specific addresses in the memory space;
specifying a doorbell address range such that one doorbell and one completion flag correspond to one data chunk of the data chunks; and
allowing the CFE to set up a required data movement for each data chunk and provide completion status.

2. The method of claim 1, wherein the information about the data chunks includes at least a number and size of the data chunks, and a base address of a source buffer.

3. The method of claim 1, wherein the doorbell address range is stored in a doorbell address location of the memory space.

4. The method of claim 1, wherein several approximately simultaneous data chunks are coalesced into a single larger transfer.

5. The method of claim 4, wherein the CFE performs the coalescing when consecutive doorbells are rung in close sequence.

6. The method of claim 5, wherein each thread rings at least one doorbell corresponding to at least one data chunk such thread completed.

7. The method of claim 6, wherein the CFE generates work queue elements (WQEs) as a response to per-chunk doorbell rings.

8. The method of claim 1, wherein a transport engine provides completion queue elements (CQEs) to the CFE.

9. The method of claim 1, wherein the CFE writes a completion flag corresponding to a transferred data chunk.

10. A system comprising:
a control frontend (CFE); and
a memory space that receives a persistent work request (P-WR) including information about data chunks, wherein an application rings a doorbell in the CFE such that the CFE:
inspects the P-WR;
sets up virtual doorbells at specific addresses in the memory space;
specifies a doorbell address range such that one doorbell and one completion flag correspond to one data chunk of the data chunks; and
allows the CFE to set up a required data movement for each data chunk and provide completion status.

11. The system of claim 10, wherein the information about the data chunks includes at least a number and size of the data chunks, and a base address of a source buffer.

12. The system of claim 10, wherein the doorbell address range is stored in a doorbell address location of the memory space.

13. The system of claim 10, wherein several approximately simultaneous data chunks are coalesced into a single larger transfer.

14. The system of claim 13, wherein the CFE performs the coalescing when consecutive doorbells are rung in close sequence.

15. The system of claim 10, wherein each thread rings at least one doorbell corresponding to at least one data chunk such thread completed.

16. The system of claim 10, wherein a transport engine provides completion queue elements (CQEs) to the CFE.

17. The system of claim 10, wherein the CFE writes a completion flag corresponding to a transferred data chunk.

18. A system comprising:
a graphics processing unit (GPU) running multiple GPU threads; and
a control frontend (CFE) communicating with the GPU to set up a memory space according to information received from a persistent work request (P-WR) including information about data chunks, and wherein the GPU threads write notifications indicating that a transfer operation needs to be constructed from the P-WR and issued to a transport engine.

19. The system of claim 18, wherein each GPU thread writes at least one notification corresponding to at least one data chunk such GPU thread completed.

20. The system of claim 18, wherein several approximately simultaneous data chunks are coalesced into a single larger transfer and the CFE performs the coalescing when consecutive doorbells are rung in close sequence.
